(19) United States
(12) Patent Application Publication
(10) Pub. No.: US 2018/0124989 A1
(43) Pub. Date: May 10, 2018

(54) HAND DIGGING TOOL

(71) Applicant: WEEDS OF SWEDEN LTD., Nicosia (CY)

(72) Inventor: Ingemar Ahlqvist, Tvååker (SE)

(21) Appl. No.: 15/573,771

(22) PCT Filed: May 20, 2016
(86) PCT No.: PCT/EP2016/061366

§ 371 Date: Nov. 13, 2017

(30) Foreign Application Priority Data
May 22, 2015 (SE) 1550653-8

(51) Int. Cl. A01B 1/04

(52) U.S. Cl. CPC A01B 1/04; B25G 1/102

(57) ABSTRACT

This invention relates to a hand tool for gardening, comprising a rigid handgrip portion (1) and a tool portion (5), said tool portion (5) comprising at least one tool member (3,4), said tool portion (5) having a concave side and having a central axis (C) extending in the direction of intended working movement of the tool member (3,4), the rigid handgrip portion (1) comprising a handgrip body (10,11,12) with a first gripping surface (11A), arranged transversally in relation to the extension of the central axis (C) of the tool portion (5) and positioned on the same side as the concave side of the tool portion (5), characterized in that a second rigid handgrip portion (2) is arranged comprising a handgrip body (20, 21) in contact with said tool portion (5) and with second gripping surface (21A) facing said first gripping surface (11A) and a gap (6) formed between said lower and upper gripping surfaces (21,11).

### TECHNICAL FIELD

This invention relates to a hand tool for gardening, comprising a rigid handgrip portion and a tool portion, said tool portion comprising at least one tool part, said tool portion having a central axis extending in the direction of intended working movement of the tool part, the handgrip portion comprising a handgrip body with a lower gripping surface, arranged transversally in relation to the extension of the central axis of the tool part and positioned above the tool portion.

### BACKGROUND

It is known to have hand tool for gardening that in contrast to traditional hand tools make it easier to grip it and apply force, comprising a rigid handgrip portion and a tool portion, said tool portion comprising at least one tool part, said tool portion having a central axis extending in the direction of intended working movement of the tool part, the handgrip portion comprising a handgrip body with a lower gripping surface, arranged transversally in relation to the extension of the central axis C of the tool part and positioned above the tool portion.

Further there is known another hand tool for gardening from GB 2481460 that is also intended make it easier to grip and apply force. However, that design is relatively complex to grip and does not make use of a rigid hand grip portion.

The above known hand tools do present some disadvantages.

### SUMMARY OF THE INVENTION

It is an object of the invention to improve the above kind of hand tool, which is achieved by means of a hand tool as defined in claim 1.

Many advantages are gained with the novel design according to the invention, e.g. easy to grip and apply force in a flexible manner by means of one and the same tool enabling ergonomical and efficient gardening in various situations.

### BRIEF DESCRIPTION OF THE FIGURES

The invention will now be further described, by way of example, with reference to the accompanying drawings, in which:

FIG. 1 is a perspective view of a hand tool according to one embodiment of the invention;

FIG. 2 is a view from above of FIG. 1;

FIG. 3 is a is a view from the side of FIG. 1; and,

FIG. 4 is a perspective view of the hand tool of FIG. 1 from another angle.

### DETAILED DESCRIPTION

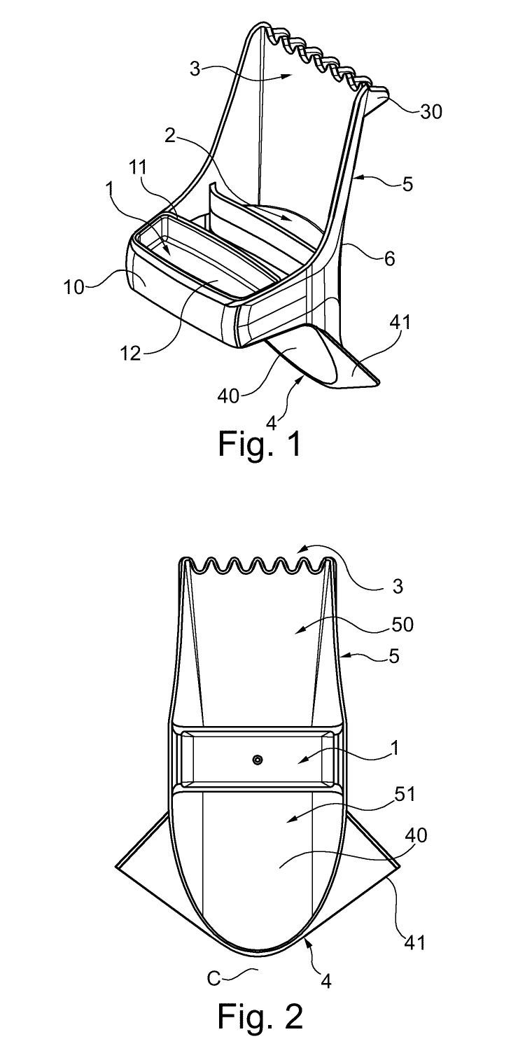

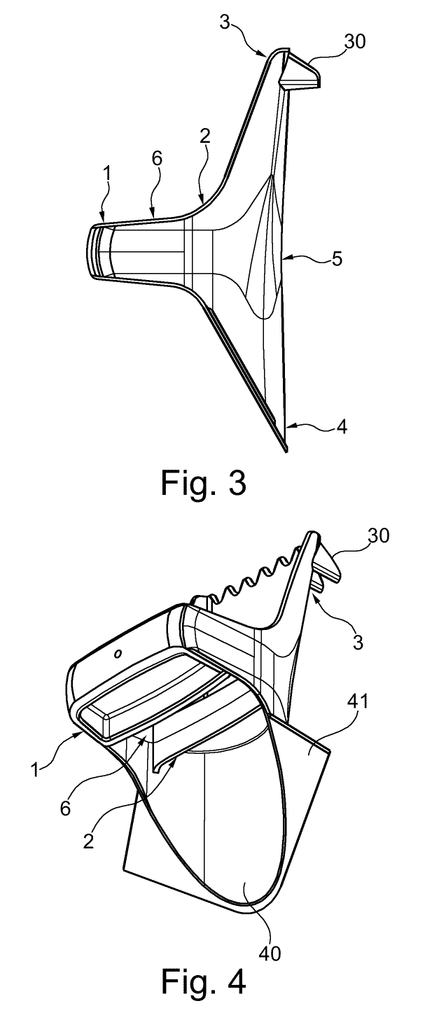

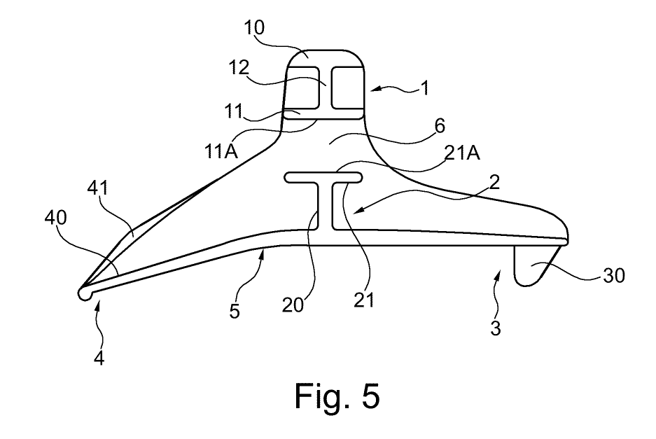

In FIGS. 1, 2, 3 and 4 there is shown a preferred embodiment of a hand tool for gardening, comprising a handgrip portion 1 and a tool portion 5, said tool portion 5 having a concave side and comprising at least one tool member 3,4 said tool portion 5 having a central axis C extending in the direction of intended working movement of the tool part 3,4, the handgrip portion 1 comprising a handgrip body 10,11,12 with a first gripping surface 11A, arranged transversally in relation to the extension of the central axis C of the tool part and positioned on the same side as the concave side of the tool portion 5.

In accordance with the invention a second handgrip portion 2 is arranged comprising a handgrip body 20, 21 in contact with said tool portion 5 and with a second gripping surface 21A facing said first gripping surface 11A and a gap 6 formed between said second and first gripping surfaces 21A,11A, wherein said second handgrip portion 2 comprises a handgrip body 20, 21 having a T-formed cross-sectional design.

The first gripping surface 21A of the second handgrip portion 2 is formed by the upper part 21 of the T-formed handgrip body 20, 21 and the leg part 20 of said T-formed handgrip body 20, 21 forms an integral part between the upper part 21 of said T-formed handgrip body 20, 21 and the tool portion 5.

The leg part 20 of said T-formed handgrip body 20, 21 may form a homogenous transversal wall dividing said the tool portion 5 into a first 50 and a second 51 tool parts. Thanks to this design there is formed limited spaces that may be used to safely carry items, e.g. seeds.

The first gripping surface 11A has an extension in parallel with said central axis C of between 20 to 60 mm, preferably at least 30 mm.

Thanks to this design a comfortable second grip is provided which allows a user to grip the hand tool from either one of the tool parts 3,4 enabling a more solid grip wherein the tool portion 5 may support the wrist when working with the opposite tool part 50,51, in relation to the gripping.

Preferably the tool portion 5 has a curved cross-section with a first tool part 51 comprising a tool member 4 in the form of a spade blade 40, that may (or may not) be arranged with at least one transversally protruding wing portion 41. More preferred tool member 3 is in the form of teeth 30 protruding on a convex side of said tool portion 5.

The invention is not limited by what has been described above but may be varied within the scope of the claims. As is evident for the skilled person many varieties of a hand tool, with different sets of tools may be used wherein the basic principle of the invention is beneficial. Further, it is evident that the second hand grip portion may have various cross sectional forms that fulfils the purpose there of.

1-8 (canceled).

9. A hand tool for gardening, comprising a rigid handgrip portion and a tool portion, said tool portion comprising at least one tool member, said tool portion having a concave side and having a central axis extending in the direction of intended working movement of the tool member, the rigid handgrip portion comprising a handgrip body with a first gripping surface, arranged transversally in relation to the extension of the central axis of the tool portion and positioned on the same side as the concave side of the tool portion and facing the concave side, characterized in that a second rigid handgrip portion separate from said first hand grip portion is arranged comprising a handgrip body in contact with said tool portion and with a second gripping surface facing said first gripping surface and a gap formed between said lower and upper gripping surfaces.

10. The hand tool according to claim 9, wherein said second handgrip portion comprises a handgrip body having a T-formed cross-sectional design.

11. The hand tool according to claim 9, wherein said second gripping surface of said second handgrip portion is formed by the part of said T-formed handgrip body that faces said first gripping surface and the leg part of said T-formed handgrip body forms an integral part between the upper part of said T-formed handgrip body and said tool portion.

12. The hand tool according to claim 11, wherein said the leg part of said T-formed handgrip body forms a transversal wall dividing said tool portion into a first and a second half.

13. The hand tool according to claim 9, wherein said second gripping surface has an extension in parallel with said central axis of between 20 to 60 mm, preferably at least 30 mm.

14. The hand tool according to claim 9, wherein said tool member comprises a spade blade.

15. The hand tool according to claim 14, wherein said tool member comprising a spade blade also is arranged with at least one transversally protruding wing portion.

16. The hand tool according to claim 9, wherein said tool member comprises teeth protruding on a convex side of said tool portion.
